(19) United States
(12) Patent Application Publication
(10) Pub. No.: US 2014/0215896 A1
(43) Pub. Date: Aug. 7, 2014

(54) Self-Locking, Spring-loaded Snare

(71) Applicant: Robert Earl Stinnett, Sealy, TX (US)

(72) Inventor: Robert Earl Stinnett, Sealy, TX (US)

(21) Appl. No.: 13/964,886

(22) Filed: Aug. 12, 2013

Related U.S. Application Data
(60) Provisional application No. 61/761,320, filed on Feb. 6, 2013.

(51) Int. Cl. A01M 23/34

(52) U.S. Cl. CPC A01M 23/34
USPC 43/87

(57) ABSTRACT

The invention is a snare threaded through a compression spring delivered to the animal via a two-jaw animal trap. The snare consists of steel or other resilient cable, a snare lock and other wire rope devices sufficient for making a snare, flexible tube, a spring retention washer, “J” clip, and a compression spring. The snare assembly is threaded through a piece of rigid tubing which serves to direct the energy of the compression spring. The compression spring causes the snare to lock upon the animal when the trap is activated, and the flexible tube reduces the possibility of rope burns or other injury to the animal.

### RELATED U.S. PATENT DOCUMENTS

This application claims the benefit of provisional patent application Ser. No. 61/761,320 filed 2013 Feb. 6 by the present inventor.

### U.S. Patent Documents

The following is a tabulation of some of the prior art that presently appear relevant:

U.S. Patents

| Patent Number | Kind Code | Issue Date | Patentee |
|---|---|---|---|
| 1,031,728 | 43/87: 48/87 | Jul. 9, 1912 | Obiols |
| 4,389,807 | 43/87; 43/96 | Jun. 28, 1983 | Novak |
| 4,581,844 | 43/87 | Apr. 15, 1986 | Torkko |
| 5,157,863 | 43/87; 43/85 | Oct. 27, 1992 | Godwin |
| 5,907,922 | 43/87; 43/88 | Jun. 1, 1999 | Belisle |
| 10,361,998 | 43/87; 43/88 | Jun. 22, 2004 | Gérard |
| 13,092,369 | 43/87 | Oct. 25, 2012 | Hoggan |

### BACKGROUND OF THE INVENTION

1. Field of the Invention

This invention relates to traps for catching animals, and in particular to so-called “humane” traps that minimize or prevent injuries to animals sustained when and after an animal is caught while providing reliable physical retention of the animal about the trap.

2. Description of Prior Art

Traps intended for the catching of animals—mainly mammals—in the wild, consist essentially of snares, or facing jaw traps. The jaws of some conventional traps are provided with sharp teeth, for penetrating deep into and maintaining firmly one of the legs of the animal caught by the trap. The pressure applied by those jaws is intended to be very strong, which has the effect of severely wounding the trapped animal before release by the trapper. Some of these animals may even die of their injuries before the trapper comes back to his trap. Snares thrown too quickly may also cause the same results. Moreover, these types of traps do not allow one to carry out a selective trapping whereby the animals so trapped cannot be released because the extent of bodily injuries sustained by these animals. Also, domestic animals, or animals protected under law (e.g. endangered species) may be accidentally trapped and injured or killed. Alternate trap embodiments that attempted to deal with the above-noted bodily injuries to the caught animal, have several drawbacks. One such drawback is that these modified traps are too easy for the trapped animal to open and freely escape therefrom, and thus are unreliable. Existing humane traps still do inflict some bodily injuries, although to a lesser degree than conventional traps with sharp teeth jaws. The unstable rigid frame of some humane traps can hamper the effective operation of the slip-knot lace involved in the animal retention. Some other humane traps can also be rendered ineffective by becoming damaged under the load of a more powerful animal, such as a feral hog. In addition, because of its leg and foot anatomy, other traps and snares that are currently available will not reliably catch and hold a feral hog. These devices rely on the struggle of the animal to tighten the snare and in struggling a hog is able to slip the snare and often free itself.

U.S. Pat. No. 1,031,728 issued in 1912 (inventor Obiols) and U.S. Pat. No. 4,389,807 issued in 1983 (inventor Novak)needs reference in prior art both show an animal trap which comprises a snare which lies on the ground in the case of the Novak device, and which lies on the ground-resting frame in the case of the Obiols patent. A trigger located centrally of the snare will release a spring-loaded arm when stepped upon, so as to pull the snare up on the animal's leg. This type of trap has been found to be unreliable, since the animal often has enough time to retrieve his leg once the mechanism is triggered and before he is ensnared. Also, this trap often moves or tilts when stepped on by the animal, which will result in the spring-loaded arm carrying the snare along the ground instead of up the animal's leg. Finally, an animal standing above the pivotal arm may prevent the trap from functioning.

U.S. Pat. No. 4,581,844 issued in 1986 (inventor Torkko) discloses an animal trap which is similar to the above-mentioned Obiols and Novak devices, with the exception that the snare rests on a unitary integral circular frame ring that is attached to the spring-loaded pivotable arm. Thus, upon the animal triggering the trap, the frame ring carries the snare in its upward pivotal displacement along the leg of the animal, to increase the likelihood that the animal will be ensnared. Although animals may indeed be caught more easily with such a snare, it remains unreliable since the pivotal motion of the long spring-loaded arm is too slow to ensnare some animals and animals standing above the pivotal arm may prevent the trap from functioning. Moreover, and more importantly, the Torkko snare will often injure animals, since the rigid frame of the trap will remain caught on the animal's leg, due to the fact that the animal leg extends through the rigid frame ring. When the animal realizes that he has been ensnared, he will kick and struggle to break free and consequently is likely to injure himself by flailing the rigid trap frame about.

U.S. Pat. No. 5,907,922 issued in 1999 (inventor Belisle) shows an animal trap comprising a ground resting frame carrying a pair of opposite, pivotal, spring-loaded jaws. The jaws will close themselves upon the animal stepping on a central trigger. A snare lace, initially located under the jaws, will close upon the animal's leg due to the animal struggling to break free from the rigid frame. However, a problem with the Belisle trap is that the rigid frame will more often than not remain attached with the snare lace on the animal's leg. As the animal kicks and struggles to break free, he will involuntarily flail the rigid frame against himself, injuring himself.

While these devices are somewhat effective on many mammals, the leg structure and potential weight of a hog presents additional complications and renders these devices ineffective. None of the afore mentioned devices will reliably place a trap or snare high enough on a hogs leg to capture it before the hog can escape. My trap reliably captures and holds the animal, uninjured, so the trapper may elect to release or collect the animal.

### DESCRIPTION OF OVERALL STRUCTURE OF INVENTION

The invention consists of a snare threaded through a compression spring and a reduced power two-jaw animal trap. In the set position the snare encircles the jaws of the trap, the compression spring providing tension which holds the snare securely on the jaws. The opposite end of the snare being firmly anchored to the ground, tree, drag, etc. The two-jaw animal trap is not anchored so that the animal may step out or kick out of it without injury.

The snare consists of steel cable, ferrules and other wire rope devices sufficient for making a snare, flexible tube, a snare lock, a spring retention washer, a “J” clip and a compression spring. The snare assembly is threaded through a piece of rigid tubing.

The trap used to deliver the snare consists of a frame, two jaws with bars welded to them to retain the snare, torsion springs, levers for setting the jaws, and a pan and dog trigger mechanism for activating the trap.

### Description of Illustrations

### Drawing Page 1/3

FIG. 1: The snare assembly in the set position and details of the spring retention washer.

FIG. 1A: Detail of the lock end of the snare in the closed, locked position.

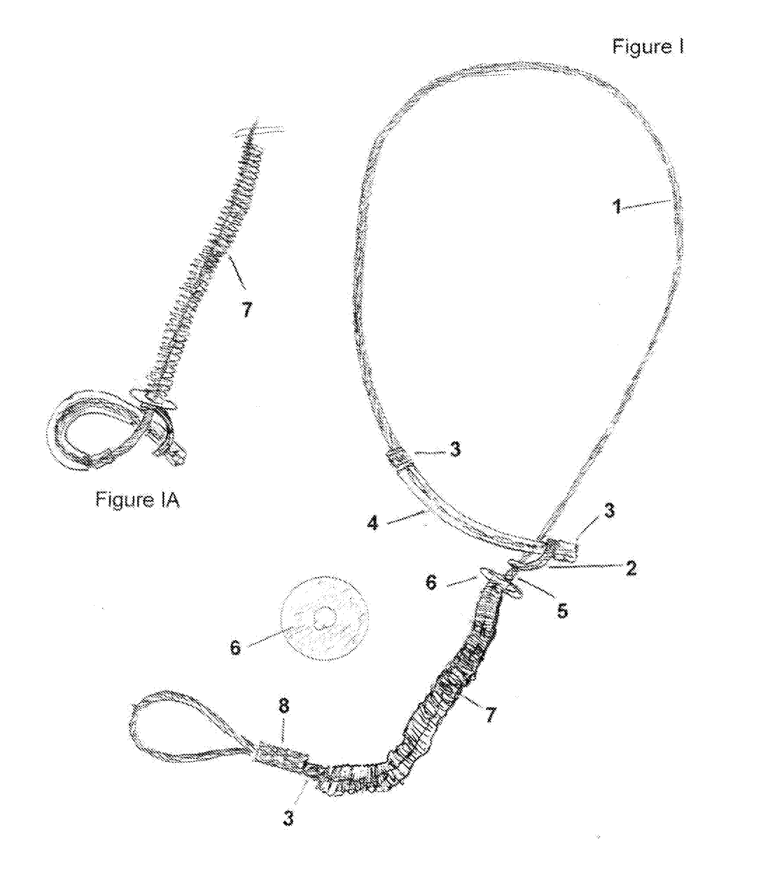

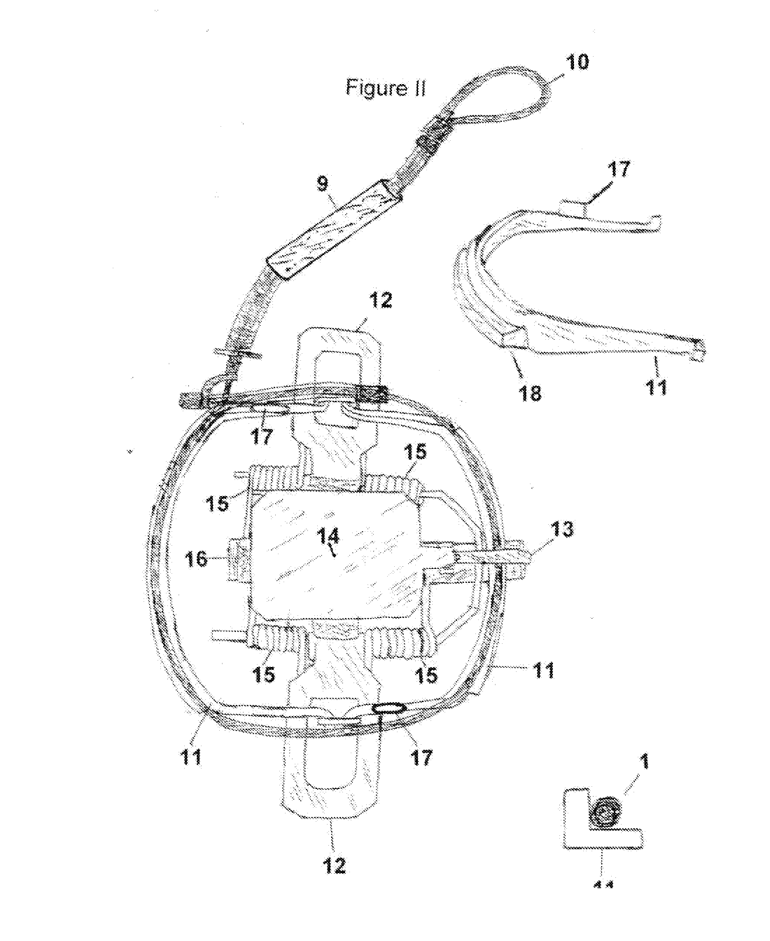

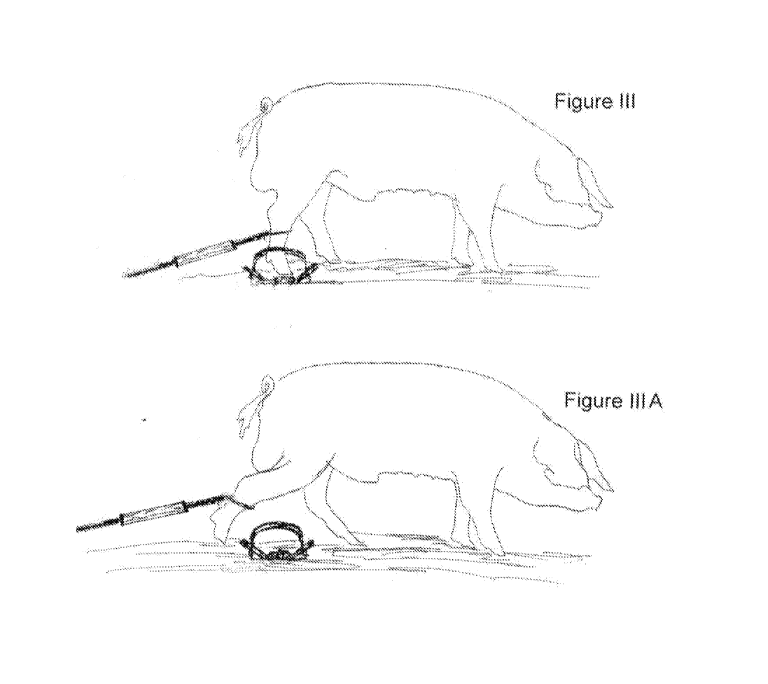

### Drawing Page 2/3

FIG. 2: A perspective view of a trap typical of the type used to deliver the snare in the set position, with the snare assembly attached and the jaws open; and details of a trap component parts.

Drawing page 3/3

Figure III: A perspective view of a hog caught by the snare

Figure IIIA: A perspective view of a hog retained by the snare after shaking off the trap.

### IDENTIFICATION OF COMPONENTS

### Drawing Page 1/3

1 galvanized steel or other flexible, resilient cable
2 snare lock
3 single ferrule
4 flexible vinyl tube
5 “J” clip
6 spring retention washer
7 compression spring
8 double ferule

### Drawing Page 2/3

9 rigid, light weight tube
10 snare assembly
11 jaws
12 levers
13 dog
14 pan
15 torsion springs
16 frame
17 offset blocks
18 snare support bar

### DETAILED DESCRIPTION OF THE INVENTION

To make the invention you begin with a length of flexible wire rope or other resilient cable suitable for constructing a snare. We begin by constructing the locking end of the snare. Place and clamp a deer stop near the end of the cable allowing sufficient cable length to slide a piece of flexible tube and the snare lock over the cable. Slide the flexible tube and the snare lock over the cable. Finish this end by clamping a single ferrule to the cable end. Pass the opposite end of the cable through the snare lock. Pass the spring retention washer over the cable. Install a “J” clip on the cable at such a distance to allow full compression of the spring behind the clip. Slide the compression spring over the cable. The spring must be of sufficient length to close the loop of the snare to the deer stop when relieved of compression. Install a single ferrule, to act as a spring stop, at a sufficient distance from the cable end to allow full compression of the spring between this single ferrule and the “J” clip. Slide a double ferrule over the cable to create the tie-off loop.

### Description of How the Invention Operates/Functions

To set the trap, begin by preparing the snare. Fully compress the snare spring and clip the spring retention washer behind the “J” clip to hold the spring under full compression. Set the snare aside.

Apply pressure to the trap levers and allow the jaws to fall open. With the jaws open, lay a section of the large loop of the snare between the pan and dog so that the snare lies on the jaw with the dog over both the snare and jaw. Position the free end of the dog under the pan to set the pan-dog trigger mechanism and push the pan to the full up position. Adjust the snare so that it completely encircles the jaws of the trap and rests on the snare support bar. The opposite end of the snare is now fed through the PVC tube and attached to the cable or chain that is anchored to the ground.

With a rocking motion, move the spring retention washer to unlock the snare spring and allow pressure on the jaws. Carefully push the pan down to the horizontal position. The Spring-Loaded Snare is now set.

The trap is activated by pressure on the pan.

When an animal of sufficient weight steps on the pan, the pan moves down releasing the dog and releasing the jaws. The pressure of the torsion springs rapidly cause the jaws to move up. This closing movement of the jaws disconnects the snare from the jaws of the trap forcing the snare to begin upward movement which is further accelerated by the rapid release of compression of the snare spring. As the spring accelerates it forces the snare to close itself around the animal's leg, engaging the lock, and firmly clamping itself. Attempts by the animal to free itself further tighten the snare. Because the snare is set at the same time that the trap is sprung, the animal remains caught by the snare as it steps out of or shakes off the two-jaw trap. The flexible tube on the lock end of the snare further prevents injury to the animal. The tube prevents the snare cable from abrading or cutting the animal thus allowing the animal to be released uninjured.

I claim:

1. An animal snare made of wire rope or other flexible, resilient cable that upon activation closes itself through the action of a compression spring comprising:
a. A snare cable having an anchoring device end and an opposite snare end.

2. The device of claim 1 contains a length of wire rope or other flexible, resilient cable

3. The device of claim 1 contains a deer stop located far enough from the end of the cable to allow installation of hardware to form the lock end of the snare;

4. The device of claim 1, wherein the snare end is contained within a length of flexible tubing.

5. The device of claim 1 contains a snare lock;

6. The device of claim 1 contains a single ferrule on the lock end of the cable;

7. The device of claim 1 contains a spring retention washer;

8. The device of claim 1 contains a “J” clip located and attached at such a distance on the cable to allow full compression of the spring behind the “J” clip;

9. The device of claim 1 contains a compression spring of sufficient length to close the loop of the snare to the deer stop when relieved of compression;

10. The device of claim 1 contains a single ferrule to act as a spring stop located a sufficient distance from the cable end to allow full compression of the spring between the spring stop and the “J” clip;

11. The device of claim 1 contains a double ferrule to form the tie-off loop;

12. The device of claim 1 contains a length of rigid, light weight tubing.

13. The device of claim 1 further comprising:
(a) whereby the snare is to be used in combination with a snare delivery device.
